(19) United States
(12) Patent Application Publication
(10) Pub. No.: US 2003/0182191 A1
(43) Pub. Date: Sep. 25, 2003

(54) Location-based wireless loyalty program

(76) Inventors: Gaugarin Oliver, Littleton, MA (US); Tonytip Ketudat, Lexington, MA (US)

Correspondence Address: Gaugarin Oliver, 6 Grist Mill Road, Littleton, MA, 01460, US

(21) Appl. No.: 10/396,954

(22) Filed: Mar. 25, 2003

Related U.S. Application Data
(60) Provisional application No. 60/366,792, filed on Mar. 25, 2002.

(51) Int. Cl. G06F 17/60

(52) U.S. Cl. 705/14

(57) ABSTRACT

The present application features a wireless subscriber using his or her wireless communication device to request information or offers pertaining to certain goods or services the subscriber is interested in. The subscriber's request is relayed by a collaborating wireless carrier to an agent which uses the subscriber's profile to determine which merchants near the subscriber's location are offering goods or services matching the request. One or more offers or suggestions are returned to the subscriber. The subscriber accepts an offer and proceeds to the physical retail outlet of the selected merchant, where the subscriber purchases the goods or services using a credit card. A collaborating credit clearing house is alerted by the agent or wireless carrier that such a transaction may have occurred, and confirmation is provided from the clearing house to the agent indicating that the transaction did indeed occur. Once confirmed by the clearing house, the agent may produce a report for the carrier indicating that the subscriber acted on the offer. Loyalty benefits, points, rebates, call minutes, etc. are then given to the subscriber in return for purchasing the goods or services in accordance with the offer. Revenues generated from the purchase are shared in a collaborative fashion between the collaborating parties to the transaction and the subscriber is encouraged to remain with the carrier through whom he or she acquired the loyalty benefits.

### RELATED APPLICATIONS

This application claims priority under 35USC119(e) to U.S. provisional patent application serial No. 60/366,792, filed on Mar. 25, 2002, which is hereby incorporated by reference.

### TECHNICAL FIELD

The present application relates to wireless communication and retail services. Specifically, aspects of the present disclosure feature systems and methods for use in wireless communication services to reduce subscriber churn and facilitate increased retail transactions among a cooperative group of business partners and service providers. Also, some aspects of the present disclosure provide for using speech recognition and natural language processing in the operation of the system. Other aspects involve determination of location-based offers to be made to wireless subscribers, and loyalty points or benefits awarded to the subscribers on accepting the offers.

### BACKGROUND

A continuing stream of technology leading to true mobile electronic commerce is in the offing. This, coupled with wireless systems that leverage the ability to determine the physical location of mobile wireless devices (and by implication, the users of the devices), is making location-based services to wireless subscribers possible.

Marketing, customer profiling, and voice-based machine interfaces are other areas of art which provide a rich source of technology for creating new and novel uses of wireless communication and electronic retail infrastructures. See for example, U.S. Pat. No. 6,292,786 to Deaton et al. describing a real-time incentive program; U.S. Pat. No. 6,286,005 to Cannon describing promotion analysis; U.S. Pat. No. 5,918,211 to Sloane describing influencing customer behavior at the point-of-sale (POS); and U.S. Pat. No. 6,301,471 to Dahm et al. describing subscriber retention techniques for users of mobile devices.

The current systems and methods however lack an efficient and practical description of how to reduce the turnover of wireless subscribers (“churn”) while generating revenue for a plurality of cooperative partners such as wireless providers and retailers. Churn is a problem for carriers at the present time and the outlook is for this problem to become more acute as the FCC mandates number portability, proposed for late 2003.

### SUMMARY

Several embodiments are provided herein to illustrate the concepts and invention provided by the present disclosure, including a method for providing subscriber loyalty incentives, featuring (A) receiving information including a wireless subscriber identity, location, and a requested item; (B) querying a database having stored information corresponding to the wireless subscriber identity, location and the requested item, as well as information corresponding to a plurality of offers; (C) using at least the information in (B), determining an offer to make to the wireless subscriber; (D) providing the offer to the wireless subscriber; (E) receiving an acceptance signal indicating the wireless subscriber's acceptance of the offer; (F) receiving a confirmation of a transaction between a merchant and the wireless subscriber corresponding to the offer; and (G) notifying a wireless carrier of the transaction to prepare an incentive for the wireless subscriber for accepting and conducting the transaction.

Also featured is a system for increasing subscriber loyalty in wireless systems, including a wireless carrier server that communicates with a wireless subscriber; a storage device containing information corresponding to the wireless subscriber and a plurality of offers; and an agent including a processor, coupled to the data storage device, the agent using information stored in the data storage device to determine an offer to be provided to the wireless subscriber and, responsive to a transaction confirmation signal received from a financial clearing center, determining an incentive for the wireless subscriber.

The present disclosure also features a machine-readable medium including stored instructions, which when executed receives information including a wireless subscriber identity, location, and a requested item; queries a database having stored information corresponding to the wireless subscriber identity, location and the requested item, as well as information corresponding to a plurality of offers; determines an offer to make to the wireless subscriber; provides the offer to the wireless subscriber; receives an acceptance signal indicating the wireless subscriber's acceptance of the offer; receives a confirmation of a transaction between a merchant and the wireless subscriber corresponding to the offer; and notifies a wireless carrier of the transaction to prepare an incentive for the wireless subscriber for accepting and conducting the transaction.

These embodiments and examples are by way of illustration and enablement of preferred methods and structures of the invention and are not exhaustive or limiting in their scope.

### BRIEF DESCRIPTION OF THE DRAWINGS

FIG. 1 illustrates a system, method and arrangement for providing offers to a subscriber of a wireless service, receiving loyalty rewards, and thus reducing subscriber churn and generating revenues according to an embodiment of the present disclosure.

### DETAILED DESCRIPTION

Generally speaking, one or more embodiments of the present disclosure include a wireless subscriber using his or her wireless communication device to request information or offers pertaining to certain goods or services the subscriber is interested in. The subscriber's request is relayed by a collaborating wireless carrier to an agent which uses the subscriber's profile to determine which merchants near the subscriber's location are offering goods or services matching the request. One or more offers or suggestions are returned to the subscriber. The subscriber accepts an offer and proceeds to the physical retail outlet of the selected merchant, where the subscriber purchases the goods or services using a credit card. A collaborating credit clearing house is alerted by the agent or wireless carrier that such a transaction may have occurred, and confirmation is provided from the clearing house to the agent indicating that the transaction did indeed occur. Once confirmed by the clearing house, the agent may produce a report for the carrier indicating that the subscriber acted on the offer. Loyalty benefits, points, rebates, call minutes, etc. are then given to the subscriber in return for purchasing the goods or services in accordance with the offer. Revenues generated from the purchase are shared in a collaborative fashion between the collaborating parties to the transaction and the subscriber is encouraged to remain with the carrier through whom he or she acquired the loyalty benefits.

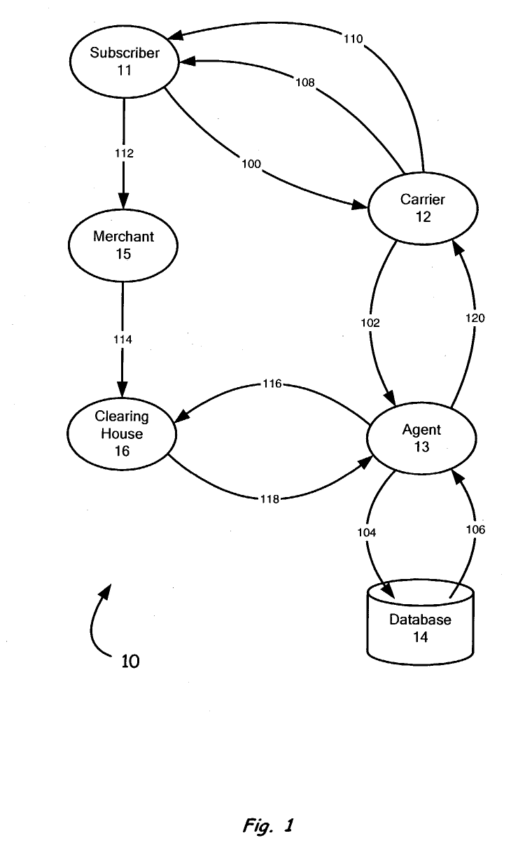

FIG. 1 illustrates an exemplary embodiment of a system 10, arrangement and method for providing offers to a subscriber of a wireless service, receiving loyalty rewards, and thus reducing subscriber churn and generating revenues for the entities involved, as described briefly above.

Subscriber 11 is interested in purchasing an item of goods. Using a wireless device, such as a cellular telephone, the subscriber 11 sends a request signal 100 to carrier 12, informing the carrier 12 of his or her interest. The request signal 100 contains information indicative of the goods or services being sought as well as information identifying the subscriber 11 and the subscriber's physical location.

The nature of the request made by subscriber 11 can vary. In some embodiments, text entry using the wireless device is used to enter the request. In other embodiments a voice command is made. That is, the wireless device and/or software at a carrier server can be used to accept inputs from subscriber 11 that are interpreted using speech recognition or natural language features.

The system 10 uses specialized semantics software, such as WordNet technology, to evaluate semantic relationship between input words and phrases to product category words and phrases. WordNet contains a large collection relationships between words and phrases. Some examples of word relationships contained in WordNet are, is-a-kind-of, is-a-part-of, synonym-of. The system searches through these relationships finding the shortest semantic distance between the input words and phrase to the target words and phrases. That way, the system is flexible enough to understand that a subscriber's request for “trousers” could be equivalent to a request for “pants,” or that a request for “magazines” might be comparable to a request for “newspapers.”

The subscriber 11 can use a variety of ways to communicate with the system 10. Subscriber 11 can provide input and receives output in the form of text, graphics and audio. The subscriber's wireless device communicates to the system 10 through a variety of well established protocols. These protocols include Wireless Application Protocol (WAP), Short Message Service (SMS), Extensible Markup Language (XML) document exchange through Hypertext Transfer Protocol (HTTP), Voice XML.

The carrier 12 sends a signal to agent 13 containing information sufficient for the agent 13 to provide one or more offers or suggestions. Specifically, the carrier 12 takes the information from the subscriber's request signal 100 and passes that information on to the agent 13 in an agreed-upon format in signal 102. The agent 13 includes hardware and/or software to partially or entirely process the subscriber's request and come up with appropriate offers. For example, the agent is implemented in computer hardware that executes software instructions suited for determining an optimum offer based on a set of inputs. Exemplary inputs include subscriber identity and location and a description of the goods being sought. Other parameters used by agent 13 in making its determination include subscriber preferences and history data. This data is stored in a database 14 coupled to agent 13, in the form of an electronic storage device operable using data processing or data mining software. Past transactions and subscriber-defined preferences are kept in database 14 to assist in offer selection and optimization. The database 14 is either a stand-alone device receiving requests 104 from agent 13 and passing data 106 to agent 13 by a data network, or is integrated into, e.g., a server memory together with agent 13.

Agent 13 carries out the logic required to determine or optimize an available offer from cooperating retailers or merchants 15 who provide the goods sought by subscriber 11. More than one possible offer may be available. Agent 13 includes an expert system in some embodiments and can adaptively improve its quality of service using artificial learning capabilities.

As an example, if the goods sought are a book then more than one cooperating local bookstore may be available to choose from. Agent 13 can then rank the available offers based on a ranking algorithm. In one embodiment, the subscriber 11 may have weighted or constrained the selection such that geographic proximity is the most important factor in the selection. In this case the nearest cooperating bookstore may be suggested to the subscriber 11. In another embodiment, the subscriber 11 may have indicated a strong interest in cost savings, in which case the best price is sought even if the offer is from a bookstore that is not the nearest to the subscriber 11 at the time he or she sends the request 100. If more than one offer are to be presented to the subscriber 11, the offers are ranked in some order and presented to the subscriber 11 as such. Of course, there may be no available offers or none at a given moment to satisfy the subscriber's wishes, in which case a response message to this effect or a ‘rain check’ or other communication is returned to the subscriber.

Offers are also dependent on dynamic merchant availability. That is, the pool of possible offers can include dynamic information that is refreshed periodically or continuously through communication with merchants 15. The merchants 15 may provide updates offers through cooperating carrier 12 or directly to agent 13 for example.

Information is exchanged between carrier 12, agent 13 and clearing house 16 through a secure XML document exchange over HTTP. Simple Object Access Protocol (SOAP) is a specific type of XML document exchange that can be used in this context.

Carrier 12 relays the offer or offers in a format compatible with the subscriber's wireless device in offer signal 108. The offer signal 108 contains information indicative of the types of goods found (a match), the price, the name and location of the merchant 15, etc. Additionally, offer signal 108 contains a code which identifies the offer uniquely so that it can be accepted by subscriber 11 and tracked later on.

Subscriber 11 receives offer signal 108 on his or her wireless device. The offer or offers are preferably in readable form, such as a text message, readable on a digital display. The short information about an offer can also be given using voice instructions to subscriber 11. If a long offer signal 108 or a plurality of offers are included in offer signal 108, subscriber 11 scrolls through offer signal 108 to read all of the information contained therein or listen to the various options.

An acceptance signal 110, indicates acceptance of an offer by subscriber 11. The acceptance signal 110 may simply include the unique code assigned to each offer at the time it was made to the subscriber 11. The acceptance or offer code is then relayed by carrier 12 back to agent 13 so that agent 13 can later query a clearing house or retailer as to fruition of a transaction corresponding to the offer.

Once subscriber 11 has received and accepted an offer, the subscriber 11 proceeds to a merchant 15 point of sale (POS) to carry out a transaction, e.g. purchase of goods, in accordance with the offer. In some embodiments, subscriber 11 goes to a retail outlet (store) and buys goods or services using a credit card known to the carrier 12 and/or agent 13. Thus, funds, or an electronic promise of payment is provided by the buying subscriber to the selling merchant 15 in signal 112. A signal 114 is sent from merchant 15 to credit card clearing house 16 in order that merchant 15 collect payment for the transaction.

One aspect of the present disclosure is that merchant 15 does not have to implement any special hardware, software or employee training at the POS to carry out the present concepts. The sale of goods or services takes place at the POS transparently in the normal fashion.

At the time of the purchase, or subsequent thereto, merchant 15 expect that the transaction is flagged by credit card clearing house 16 and information confirming the transaction is returned to agent 13. This may be triggered in more than one way: for example, agent 13 may have pre-alerted clearing house 16 in probe signal 116 that a transaction (credit card number, merchant ID, etc.) might be expected, because the subscriber 11 indicated an acceptance of a given offer. Also, agent 13 may inquire in probe signal 116 whether such a transaction took place, and then receive an answer signal 118 from clearing house 16 indicative of whether the transaction took place and possibly containing other information related to the transaction (e.g., amount, time, place).

Once agent 13 confirms that a purchase or transaction did indeed take place responsive to an offer sent to subscriber 11, the agent 13 informs carrier 12 of this fact in signal 120.

At this point it could be assumed that the transaction being reported was brokered using the system 10 through a collaboration of agent 13, carrier 12, merchant 15 and clearing house 16. A certain revenue or profit is generated as a result of both the transaction for goods or services, as well as the subscriber 11 use and loyalty to the wireless services of carrier 12.

Specifically, subscriber is served through the method and system of FIG. 1 by finding desirable offers for goods and services available locally from merchant 15. Merchant 15 receives the benefits of extra sales/transactions from referred customers who subscribe to the wireless service. Clearing house 16 and agent 13 receive a benefit in some embodiments by sharing in the resulting profits and benefits of the abovedescribed transactions, such as by direct payment from carrier 12 and/or merchant 15. Such payments may be made according to any arrangement, e.g., flat payments, periodic payments, or preferably in transaction-based payments. Transaction-based payments can in turn be calculated as a flat payment per confirmed brokered transaction, or preferably as a percentage of the monetary amount of the transaction.

Subscriber 11 collects benefits through participation in the loyalty program. A digital “purse” or “wallet” account can be maintained by any of carrier 12 or agent 13 to indicate what benefits subscriber 11 has collected to date. The account may contain “points” redeemable for cash, free wireless minutes, discounts, services, etc. Subscriber 11 can access the account by some method such as by logging into a secure Web site linking the subscriber 11 to information regarding the account. In one embodiment agent 13 keeps data about the subscriber's account in database 14.

Once a subscriber 11 collects benefits through the loyalty program, and once the subscriber 11 appreciates the system 10 and learns how to take advantage of its referral and offer capabilities, the subscriber 11 will be inclined to remain with the same carrier 12 to avoid losing the accumulated loyalty benefits and to keep receiving the services provided by system 10.

Other benefits to one or more of the collaborating parties (especially to carrier 12 and merchant 15) include the collection and analysis of subscriber 11 purchase behavior and preferences for marketing purposes. Agent 13 can monetize this transaction information in some embodiments and may sell the information as a commodity in itself to marketing agencies or other retailers or consumer research organizations.

It can be seen that the system 10 can be augmented by numerous auxiliary service providers and steps that can be integrated for the same general result. It should be appreciated that the method and system 10 described above is a collaborative effort, and hence, the type of loyalty program described above is sometimes referred to as a “coalition loyalty” program. The end result of one or more of the aspects described herein is to increase the average revenue per user (ARPU).

The system 10 is “scalable,” and can handle large number of point of sale terminals because it does not require any hardware or software associated with each POS. Even though the total number of subscribers is large, the system can process multiple user requests simultaneously since requests are not dependent on each other. In addition, the system may queue user requests for delayed processing while interacting with the user.

The system 10 can use a subscriber's speed dial list, and “buddy list” to find other subscribers. The profiles of subscribers that an individual subscriber 11 has a relationship with can be use to influence the profile of the subscriber 11. In addition, promotions can be offered such that a subscriber receives rewards if other subscribers that he/she has relationship with performs certain tasks. The tasks may include viewing of a promotion, purchasing an item as a result of a promotion.

Upon review of the present description and embodiments, those skilled in the art will understand that modifications and equivalent substitutions may be performed in carrying out the invention without departing from the essence of the invention. Thus, the invention is not meant to be limited by the embodiments described explicitly above, rather it should be construed by the scope of the claims that follow.

What is claimed is:

1. A method for providing subscriber loyalty incentives, comprising:
(A) receiving information including a wireless subscriber identity, location, and a requested item;
(B) querying a database having stored information corresponding to the wireless subscriber identity, location and the requested item, as well as information corresponding to a plurality of offers;
(C) using at least the information in (B), determining an offer to make to the wireless subscriber;
(D) providing the offer to the wireless subscriber;
(E) receiving an acceptance signal indicating the wireless subscriber's acceptance of the offer;
(F) receiving a confirmation of a transaction between a merchant and the wireless subscriber corresponding to the offer; and
(G) notifying a wireless carrier of the transaction to prepare an incentive for the wireless subscriber for accepting and conducting the transaction.

2. The method of claim 1, further comprising sending a probe signal to a financial clearing center to confirm the occurrence of the transaction.

3. The method of claim 1, wherein receiving the information in (A) comprises receiving the information in (A) from the wireless carrier.

4. The method of claim 1, wherein determining the offer comprises determining an optimum offer.

5. The method of claim 1, further comprising processing a spoken command from the wireless subscriber using a natural language algorithm.

6. The method of claim 1, further comprising matching the offer to a set of subscriber information stored in the database.

7. A system for increasing subscriber loyalty in wireless systems, comprising:
a wireless carrier server that communicates with a wireless subscriber;
a storage device containing information corresponding to the wireless subscriber and a plurality of offers; and
an agent including a processor, coupled to the data storage device, the agent using information stored in the data storage device to determine an offer to be provided to the wireless subscriber and, responsive to a transaction confirmation signal received from a financial clearing center, determining an incentive for the wireless subscriber.

8. The system of claim 7, further comprising a speech recognition engine that parses spoken commands from the wireless subscriber.

9. The system of claim 7, wherein the storage device further contains data corresponding to a subscriber loyalty account (digital purse).

10. A machine-readable medium including stored instructions, which when executed:
receives information including a wireless subscriber identity, location, and a requested item;
queries a database having stored information corresponding to the wireless subscriber identity, location and the requested item, as well as information corresponding to a plurality of offers;
determines an offer to make to the wireless subscriber;
provides the offer to the wireless subscriber;
receives an acceptance signal indicating the wireless subscriber's acceptance of the offer;
receives a confirmation of a transaction between a merchant and the wireless subscriber corresponding to the offer; and
notifies a wireless carrier of the transaction to prepare an incentive for the wireless subscriber for accepting and conducting the transaction.
